(19) United States
(12) Patent Application Publication
(10) Pub. No.: US 2026/0172977 A1
(43) Pub. Date: Jun. 18, 2026

(54) DISTRIBUTED UNIT POWER CONTROL COORDINATION FOR MULTI-VENDOR CARRIER AGGREGATION

(71) Applicant: QUALCOMM Incorporated, San Diego, CA (US)

(72) Inventors: Chiranjib Saha, Lakeside, CA (US); Alberto Rico Alvarino, San Diego, CA (US); John Wallace Nasielski, San Diego, CA (US); Abhishek Saurabh Sachidanand Sinha, San Diego, CA (US)

(21) Appl. No.: 18/978,684

(22) Filed: Dec. 12, 2024

(51) Int. Cl. H04W 52/14; H04W 52/02

(52) U.S. Cl. CPC H04W 52/143; H04W 52/0235

(57) ABSTRACT

Various aspects of the present disclosure generally relate to wireless communication. In some aspects, coordination of power control in multi-vendor carrier aggregation deployments is performed. When a primary cell and secondary cell are terminated at different distributed units, power control coordination becomes necessary because a user equipment monitors power control commands only in the common search space of its primary cell. A secondary distributed unit transmits a power control request message containing downlink control information payload to a primary distributed unit over an interface between the distributed units. The primary distributed unit then transmits the power control commands in its common search space where the user equipment is monitoring. Disclosed techniques enable power control coordination across distributed units from different vendors while maintaining existing user equipment behavior, which allows operators to expand network capabilities through multi-vendor distributed unit deployments.

### FIELD OF THE DISCLOSURE

This disclosure relates generally to wireless communication, and more specifically, to distributed unit power control coordination for multi-vendor carrier aggregation when a primary cell and secondary cell are terminated at different distributed units in a radio access network.

### BACKGROUND

In wireless networks, carrier aggregation allows multiple carriers to be combined to increase bandwidth and improve network performance. As networks evolve, operators may deploy distributed units (DUs) from different vendors to support expansion, add new capabilities, or upgrade their networks. When carrier aggregation spans across DUs from different vendors, coordination between these DUs becomes necessary.

In multi-vendor deployments, a first DU may host a primary cell (PCell) while a second DU hosts one or more secondary cells (SCells). For uplink transmissions, proper power control is needed to maintain signal quality and manage interference. A user equipment (UE) is configured to monitor power control commands, specifically Downlink Control Information (DCI) format 2_2 messages, in the common search space of its PCell. However, when SCells are hosted by a different DU than the PCell, traditional power control mechanisms face limitations since the UE only monitors these commands from its PCell.

Existing interfaces between network components, such as Xn (between central units), F1 (between central units and distributed units), and Open Fronthaul (between distributed units and radio units), do not support direct communication between DUs. This creates challenges for coordinating power control across DUs from different vendors, particularly when one DU needs to issue power control commands for its SCell but cannot directly reach the UE through the common search space.

### SUMMARY

The systems, methods and devices of this disclosure each have several innovative aspects, no single one of which is solely responsible for the desirable attributes disclosed herein.

One innovative aspect of the subject matter described in this disclosure can be implemented in a first network node. The first network node includes one or more memories and one or more processors configured to receive, from a second network node, a power control request message on an interface between the first network node and the second network node, where the power control request message comprises a downlink control information (DCI) payload for power control. The processors are further configured to transmit, in a common search space monitored by a user equipment (UE), a DCI message comprising the DCI payload.

In some examples, the interface comprises a D2 interface and the messages include specific formats, such as an Apply TPC Request message and at least a DCI format 2_2 message. The power control request message may include identifiers for source, target, and UE. The DCI payload may comprise a block identifier for a serving cell and corresponding transmit power control command. Some implementations involve sequencing transmit power control commands, including first commands for serving cells of the first network node and second commands from the power control request message. The node may transmit response messages indicating resource availability status and handle power control group indexing.

Another innovative aspect of the subject matter described in this disclosure can be implemented in a wireless communication device. The device includes processors configured to transmit a power control request message to a second network node on an interface and initiate a timer for the power control request message.

In some examples, this implementation includes handling timer expiration through failure status selection, managing message identifiers, processing DCI payloads with block identifiers and transmit power commands, and coordinating response messages with success status determination before timer expiration.

Another innovative aspect of the subject matter described in this disclosure can be implemented in a method for wireless communication by a wireless communication device. The method includes receiving a power control request message from a second network node and transmitting a DCI message in a common search space monitored by a UE.

In some examples, the method includes aspects regarding interface specifications, message formats, identifier handling, and command sequencing similar to those described for the apparatus implementations.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network with carrier aggregation capabilities, in accordance with the present disclosure.

FIG. 2 is a diagram illustrating an example disaggregated network node architecture supporting multi-vendor distributed units, in accordance with the present disclosure.

FIG. 3 is a diagram illustrating an example associated with interfaces between central units and distributed units (DUs) in a carrier aggregation deployment, in accordance with the present disclosure.

FIG. 4 is a diagram illustrating an example associated with D2 interface connections between primary and secondary DUs, in accordance with the present disclosure.

FIG. 5 is a diagram illustrating an example message flow for power control coordination between a primary DU and a secondary DU, in accordance with the present disclosure.

FIG. 6 is a diagram illustrating an example message flow for timer-based power control request handling between distributed units, in accordance with the present disclosure.

FIGS. 7 and 8 are diagrams illustrating example processes associated with power control coordination between distributed units, in accordance with the present disclosure. FIG. 7 illustrates operations at a primary DU receiving power control requests, and FIG. 8 illustrates operations at a secondary DU transmitting power control requests.

FIGS. 9 and 10 are diagrams of example apparatuses for wireless communication implementing power control coordination in multi-vendor carrier aggregation scenarios, in accordance with the present disclosure.

FIG. 11 is a diagram illustrating an example process associated with downlink carrier aggregation message flows between distributed units, in accordance with the present disclosure.

FIG. 12 is a diagram illustrating an example process associated with downlink carrier aggregation procedures between distributed units, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Modern wireless communication networks employ distributed architectures where user equipment may be served by multiple distributed units operating across different frequency carriers. These architectures support various services including voice, data, and messaging traffic through multiple-access technologies such as OFDMA and SC-FDMA, often utilizing carrier aggregation to enhance capacity and performance.

In multi-vendor deployments, distributed units from different manufacturers handle primary and secondary cells—presenting unique challenges for coordinating uplink power control. Traditional interfaces between network elements—such as Xn between central units or F1 between central units and distributed units—do not support direct distributed unit communication, and as such, latency and computational overhead are increased when coordinating through higher network layers.

Power control coordination becomes particularly complex in carrier aggregation scenarios because user equipment monitors transmit power control commands (specifically DCI format 2_2) exclusively in the common search space of its primary cell. When a secondary distributed unit needs to adjust uplink power for its serving cells, such as during semi-persistent scheduling of voice traffic, it cannot directly transmit these commands to the user equipment. This limitation creates a need for efficient coordination between distributed units.

Techniques described herein utilize a D2 interface between distributed units that enables direct power control coordination through structured message formats and procedures. A secondary distributed unit initiates coordination by sending a power control request message containing DCI payload to the primary distributed unit. This payload includes block identifiers mapped from UE context information and corresponding transmit power commands. Upon receiving the request, the primary distributed unit can perform multiple operations: mapping cell identifiers to block numbers, sequencing power control commands from both units, and transmitting the combined commands in its common search space. The protocol includes response messaging with specific status indicators and timer-based validation to ensure reliable command delivery while maintaining existing user equipment behavior and power control mechanisms.

Particular implementations of the subject matter described in this disclosure may be implemented to realize one or more of the following potential advantages or benefits. In some aspects, the present disclosure provides techniques for enabling carrier aggregation across multi-vendor distributed units while significantly reducing coordination latency and computational overhead compared to traditional central unit-based approaches. Direct communication between distributed units through the D2 interface eliminates multiple network hops and associated processing delays. For example, when a secondary distributed unit handling voice traffic needs to adjust uplink power during semi-persistent scheduling, power control commands reach the primary distributed unit directly rather than traversing central unit interfaces. This path enables faster power adjustments and more efficient resource utilization.

The message format carrying power control commands provides flexibility while maintaining backward compatibility. A user equipment continues monitoring its configured common search space as usual while power control coordination occurs transparently between distributed units. This allows network operators to introduce distributed units from different vendors without modifying user equipment behavior or existing power control procedures.

Command sequencing at the primary distributed unit ensures coherent power control across all serving cells. By combining local commands with those received from secondary units according to rules, consistent uplink power management is maintained

even when cells have different requirements or scheduling patterns. Such coordination extends to scenarios involving multiple power control groups and various traffic types, e.g., from periodic voice transmission to bursty data services.

Further, the inclusion of status messaging and timer mechanisms provides built-in reliability through clear success/failure indicators. When downlink resources become temporarily unavailable a node can quickly detect and recover from these conditions without disrupting overall network operation. Support for power control group indexing enables precise management of different cell configurations, thereby allowing operators to optimize power control for diverse deployment scenarios and service requirements.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

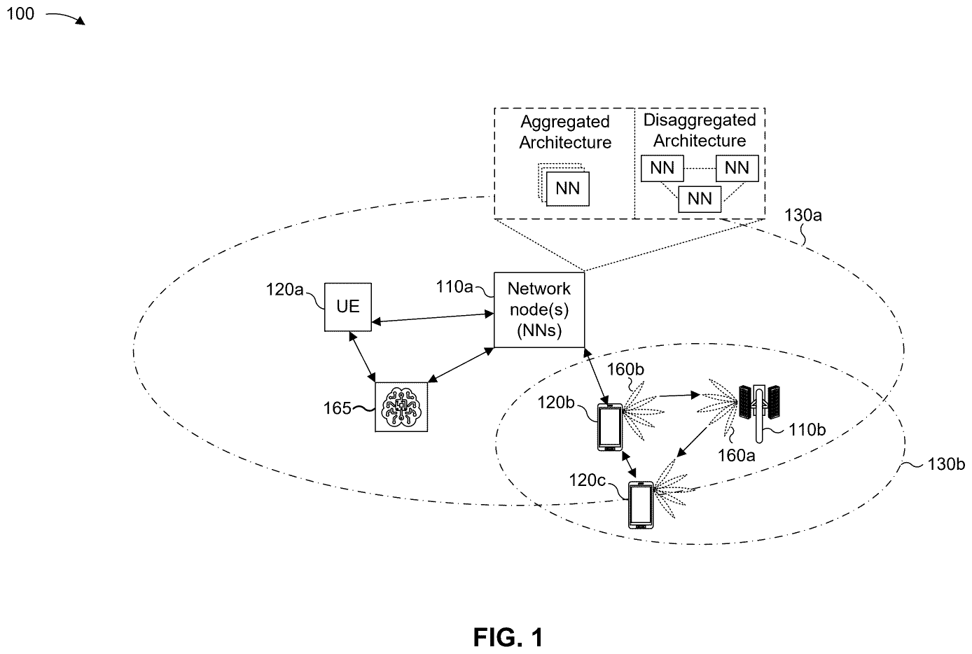

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

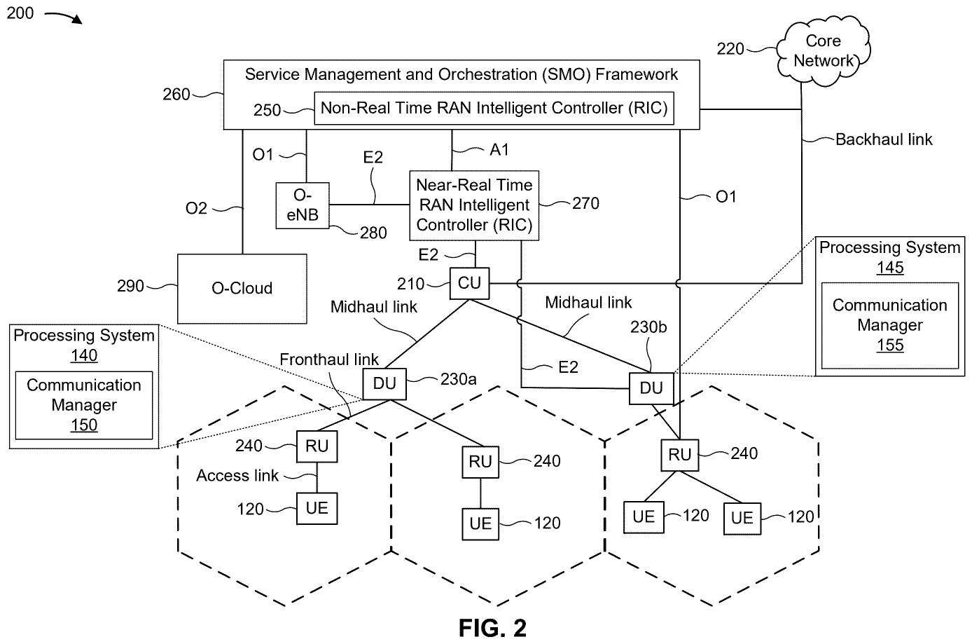

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more CUs, one or more DUs, and one or more RUs. A CU may host one or more higher layers, such as a radio resource control (RRC) layer, a packet data convergence protocol (PDCP) layer, and a service data adaptation protocol (SDAP) layer, among other examples. A DU may host one or more of an RLC layer, a MAC layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O 1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of

applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

In some aspects, a DU 230a may include a processing system 140 that includes a communication manager 150. As described in more detail elsewhere herein, the communication manager 150 may receive, from a MAC entity of a DU 230b and at an RLC entity of the DU 230a, a request for data on an interface between the DUs 230a and 230b, and may transmit an RLC PDU on the interface. Additionally, or alternatively, the communication manager 150 may perform one or more other operations described herein.

In some aspects, the DU 230b may include a processing system 145 that includes a communication manager 155. As described in more detail elsewhere herein, the communication manager 155 may transmit, from a MAC entity of the DU 230b and to an RLC entity of the DU 230a, a request for data on an interface between the DUs 230a and 230b, and may receive an RLC PDU on the interface. Additionally, or alternatively, the communication manager 155 may perform one or more other operations described herein.

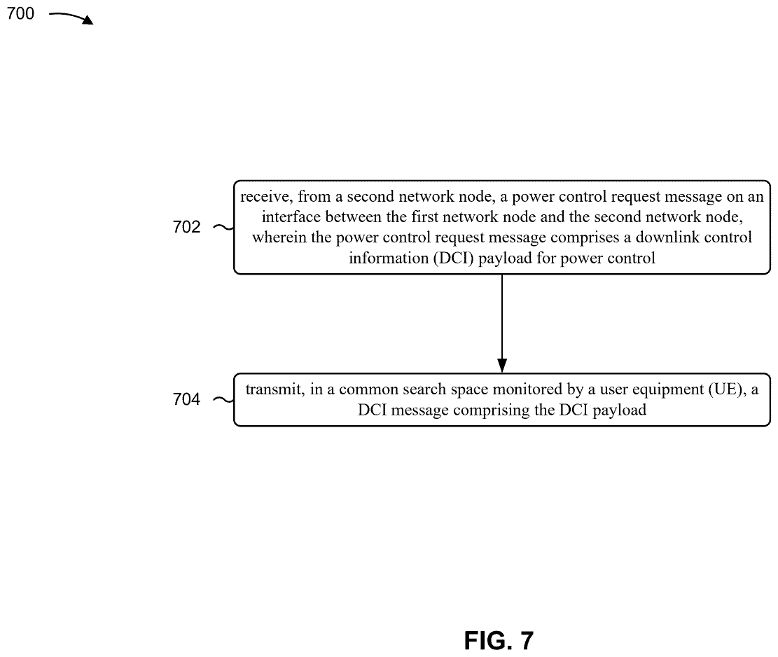

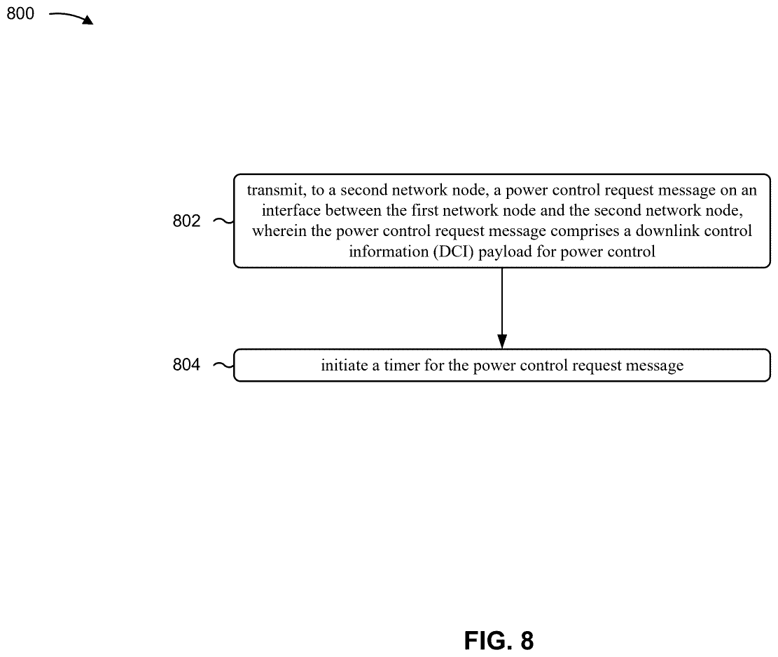

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with DU interfacing for data transmission, as described in more detail elsewhere herein. For example, the processing system 145 of the network node 110, the processing system 140 of the UE 120, the CU 210, the DU 230, or the RU 240 may perform or direct operations of, for example, process 700 of FIG. 7, process 800 of FIG. 8, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 700 of FIG. 7, process 800 of FIG. 8, or other processes as described herein. In some examples, executing instructions may include running the instructions, converting the instructions, compiling the instructions, and/or interpreting the instructions, among other examples.

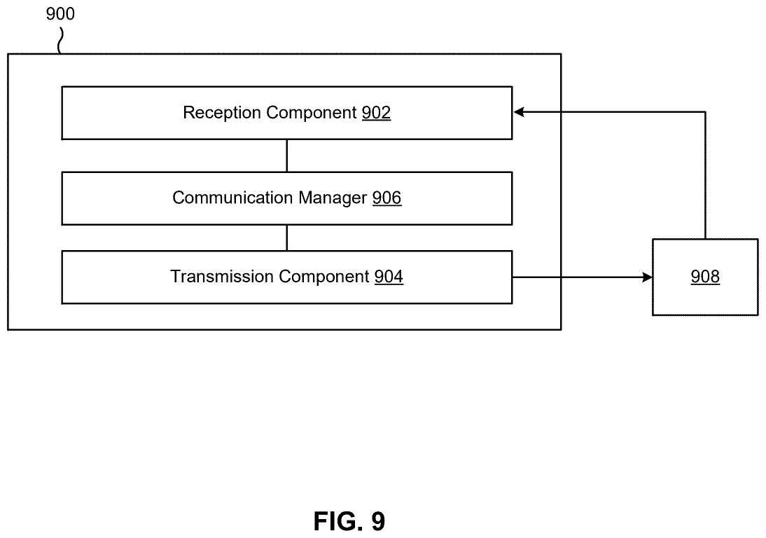

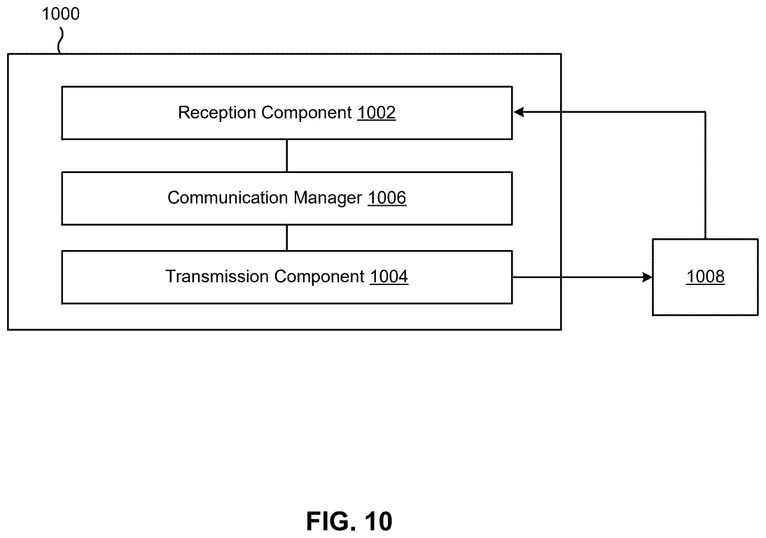

In some aspects, a first DU (e.g., DU 230a and/or apparatus 900 of FIG. 9) may include means for receiving, from a MAC entity of a second DU (e.g., DU 230b and/or apparatus 1000 of FIG. 10) and at an RLC entity of the first DU, a request for data on an interface between the first DU and the second DU; and/or means for transmitting an RLC PDU on the interface. In some aspects, the means for the first DU to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG. 9), and/or a transmission component (for example, transmission component 904 depicted and described in connection with FIG. 9), among other examples.

In some aspects, a first DU (e.g., DU 230b and/or apparatus 1000 of FIG. 10) may include means for transmitting, from a MAC entity of the first DU and to an RLC entity of a second DU (e.g., DU 230a and/or apparatus 900 of FIG. 9), a request for data on an interface between the first DU and the second DU; and/or means for receiving an RLC PDU on the interface. In some aspects, the means for the first DU to perform operations described herein may include, for example, one or more of communication manager 155, processing system 145, a radio, one or more RF chains, one or more transceivers, one or more antennas, one or more modems, a reception component (for example, reception component 1002 depicted and described in connection with FIG. 10), and/or a transmission component (for example, transmission component 1004 depicted and described in connection with FIG. 10), among other examples.

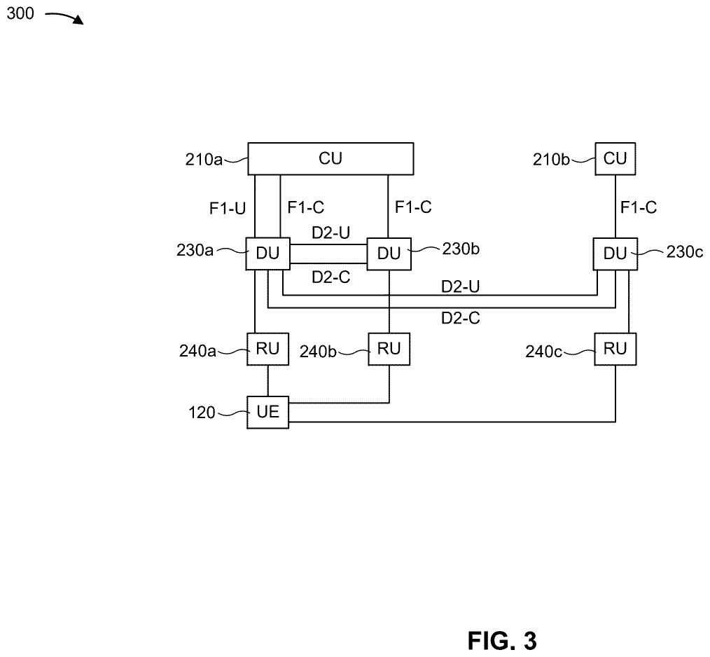

FIG. 3 is a diagram illustrating an example 300 associated with interfaces for CUs and DUs, in accordance with the present disclosure. As shown in FIG. 3, a first DU 230a may host a primary cell for a UE 120 (e.g., via an RU 240a), and a second DU 230b and a third DU 230c may host secondary cells for the UE 120 (e.g., via an RU 240b and an RU 240c, respectively). A first CU 210a may serve the first DU 230a and the second DU 230b. Accordingly, the first CU 210a may provide control information to the first DU 230a over an F1-C interface and may provide control information to the second DU 230b over another F1-C interface. Because the DUs 230a and 230b are coordinating data delivery to the UE 120 (e.g., using CA, as one example), the first CU 210a may provide data only to the first DU 230a over an F1-U interface. The first DU 230a may then deliver some of the data to the second DU 230b over a D2-U interface. In some aspects, the DUs 230a and 230b may additionally coordinate at least some control information using a D2-C interface.

As further shown in FIG. 3, a second CU 210b may serve the third DU 230c. Accordingly, the second CU 210b may provide control information to the third DU 230c over an F1-C interface. Because the DUs 230a and 230c are coordinating data delivery to the UE 120 (e.g., using CA, as one example), the first DU 230a may deliver some of the data (from the first CU 210a) to the third DU 230c over a D2-U interface. In some aspects, the DUs 230a and 230c may additionally coordinate at least some control information using a D2-C interface.

By using techniques as described in connection with FIG. 3, the D2-U interfaces allow coordination between the DUs 230a, 230b, and 230c without communicating through the CU 210a or between the CUs 210a and 210b. As a result, latency in coordinating data delivery to the UE 120 is reduced. Additionally, computing costs are reduced that otherwise would have been incurred by the CU 210a and/or the CU 210b.

As indicated above, FIG. 3 is provided as an example. Other examples may differ from what is described with respect to FIG. 3.

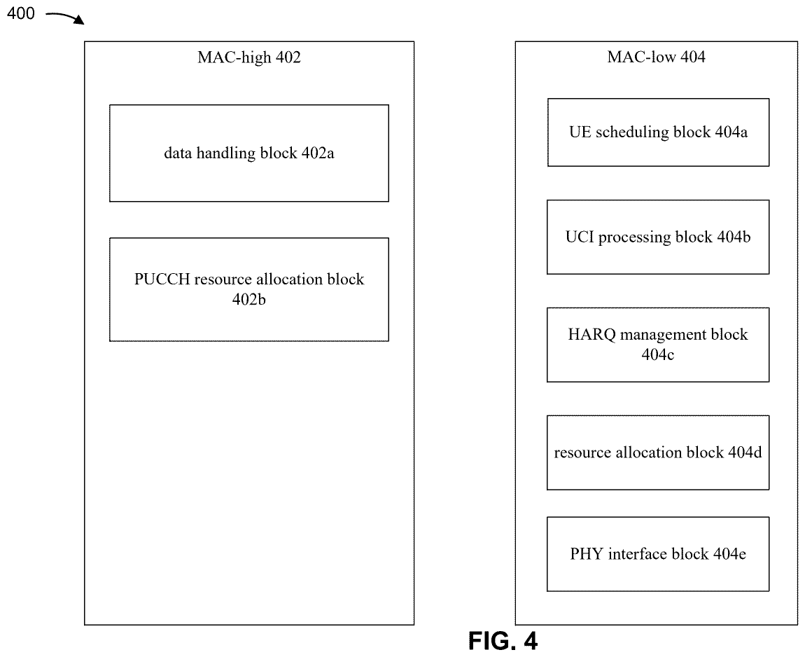

FIG. 4 is a diagram illustrating an example 400 associated with MAC layer functional division for distributed units, in accordance with the present disclosure. The example 400 includes a MAC-high entity 402 and a MAC-low entity 404 that operate together to support efficient coordination between distributed units.

The MAC-high entity 402 includes two primary functional blocks that handle higher-layer MAC operations. A data handling block 402a performs an integrated chain of data processing operations including reception of MAC service data units (SDUs), addition of MAC headers to the SDUs, multiplexing of the processed SDUs, and formation of transport blocks. These operations prepare data for efficient transmission while maintaining proper protocol encapsulation. A PUCCH resource allocation block 402b manages the assignment of physical uplink control channel resources to enable coordinated transmission of uplink control information from user equipment.

The MAC-low entity 404 includes five functional blocks that handle time-sensitive MAC operations. A UE scheduling block 404a determines scheduling assignments for connected user equipment and manages the temporal allocation of network resources. A UCI processing block 404b handles uplink control information, including scheduling control information (SCI) and hybrid automatic repeat request (HARQ) feedback, providing input for dynamic resource allocation decisions. A HARQ management block 404c coordinates the HARQ process by, e.g., including tracking transmission status and managing retransmissions when necessary. Block 404c operates to ensure data delivery through systematic retransmission protocols. A resource allocation block 404d handles the assignment of physical downlink control channel (PDCCH) and physical downlink shared channel (PDSCH) resources and manages the specific time-frequency resources used for transmission. A PHY interface block 404e manages the delivery of data to the physical layer to ensure proper formatting and timing of transmissions to lower protocol layers.

In some implementations, when deployed in a carrier aggregation scenario with multiple distributed units, a first distributed unit 230a hosting a primary cell (PCell) implements both the MAC-high entity 402 and MAC-low entity 404 to maintain full control over its serving cells. The blocks within MAC-high entity 402 coordinate with corresponding blocks in MAC-low entity 404 through internal interfaces. A second distributed unit 230b hosting secondary cells (SCells) primarily utilizes the blocks of MAC-low entity 404 while coordinating with the blocks of MAC-high entity 402 in the first distributed unit 230a through a D2 interface.

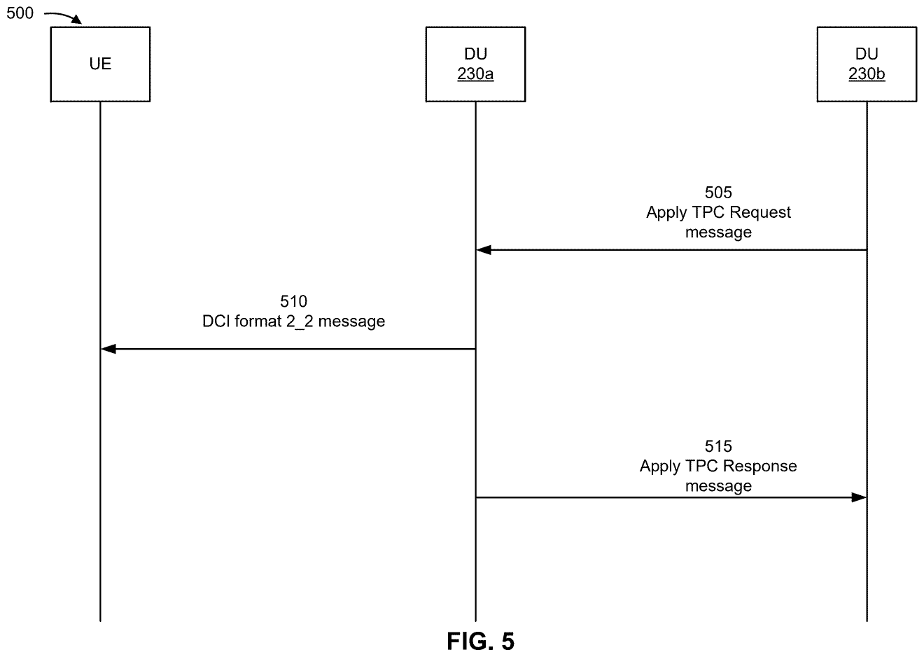

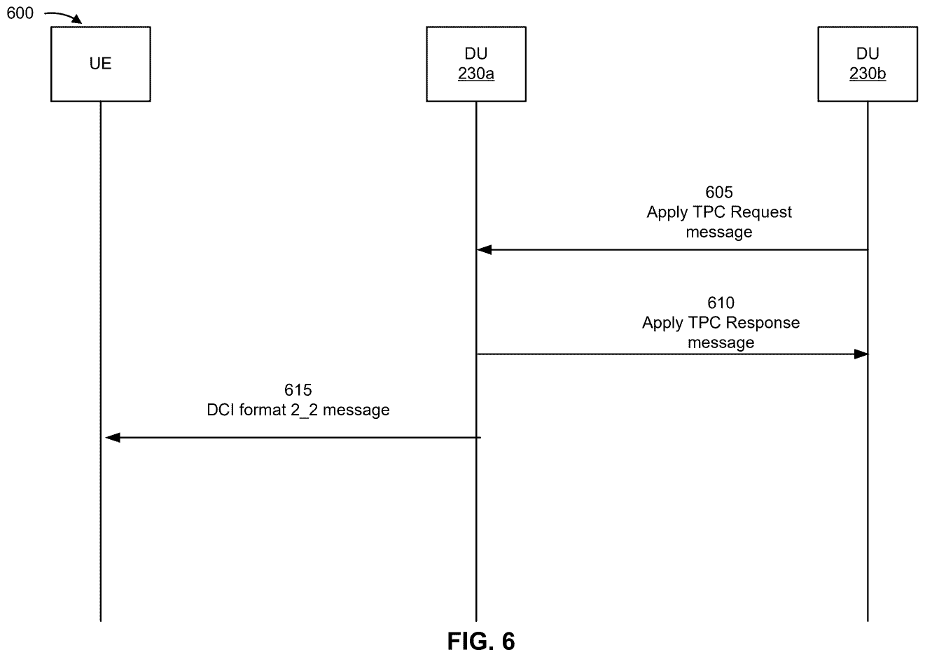

This functional division enables efficient carrier aggregation operations by maintaining separation between data preparation and resource allocation functions in MAC-high entity 402 and real-time scheduling and transmission management functions in MAC-low entity 404. The functional blocks facilitate flexible deployment across distributed units while supporting the power control coordination mechanisms illustrated at FIGS. 5 and 6.

For downlink carrier aggregation, the first DU 230a can share available buffer information with the second DU 230b through, e.g., a Buffer Indication message via the D2 interface. The second DU 230b can use one or more scheduling algorithms to schedule the UE 120 and then request data from the first DU 230a. The first DU 230a allocates PUCCH resources and retrieves the user data according to the request received from the second DU 230b. The first DU 230a then sends this data to the second DU 230b for transmission to the UE 120.

In terms of protocol operation, when the O-CU-UP sends a DL Data Request to the first DU 230a, the RLC entity of the first DU 230a indicates buffer occupancy to its MAC entity. This buffer occupancy information is then shared with the second DU 230b through a DL Buffer Indication message. Based on this information, the second DU 230b performs UE scheduling and TB size calculation, after which it sends a request for DL data and PUCCH resources back to the first DU 230a. The first DU 230a's RLC entity then prepares RLC PDUs fitting the requested transport block size and sends them along with PUCCH resource information (including K1, DAI, HARQ PID, and PUCCH Resource for DCI format 1_1) to the second DU 230b. The second DU 230b can then proceed with PDCCH and PDSCH transmission to the UE 120.

For feedback handling, PUCCH can be received by the first DU 230a, even for cells served by the second DU 230b. Upon receiving PUCCH information, the first DU 230a can share this information with the second DU 230b through UCI indication messages. For retransmissions, the second DU 230b can request additional PUCCH resources from the first DU 230a as needed. When the transmission succeeds, the second DU 230b indicates the success to the first DU 230a through a UE Data status indication message.

FIG. 5 is a diagram illustrating an example 500 associated with power control coordination over a DU interface, in accordance with the present disclosure. As shown in FIG. 5, a user equipment (UE), primary distributed unit (P-DU), and secondary distributed unit (S-DU) may communicate with each other (e.g., using a D2 interface between the DUs, as described in connection with FIGS. 3-4).

As shown by reference number 505, the S-DU may transmit, and the P-DU may receive, a power control request message. The S-DU may transmit, and the P-DU may receive, the request on the D2 interface between the DUs. The request may be, e.g., an “Apply TPC Request” message to be defined in O-RAN Alliance specifications and/or another standard. The message includes source and target DU identifiers, a UE identifier, and a DCI payload comprising a block identifier for a serving cell of the S-DU and a transmit power control command for that serving cell.

In some aspects, the S-DU may include a power control group index in the request message when multiple power control groups are conFig.d for the serving cell. The power control group index may correspond to specific PUSCH power control configurations (e.g., twoPUSCH-PC-AdjustmentStates). Additionally, the S-DU may transmit such requests during semi-persistent scheduling scenarios, such as when handling voice traffic on its serving cells that require regular power adjustments.

As shown by reference number 510, the P-DU may transmit, and the UE may receive, a DCI format 2_2 message in the common search space. The P-DU may sequence the power control commands, combining commands for its locally served cells with those received from the S-DU. The DCI message includes the sequenced commands formatted according to specifications for transmission of TPC commands for PUCCH and PUSCH.

As shown by reference number 515, the P-DU may transmit, and the S-DU may receive, a response message indicating the transmission status of the DCI message. The P-DU may transmit, and the S-DU may receive, the response on the D2 interface. The response indicates availability or unavailability of downlink resources used for the DCI transmission. The S-DU may maintain a timer from the initial request transmission and declare a failure if no response is received before timer expiration.

By using techniques as described in connection with FIG. 5, the S-DU may coordinate power control commands through the P-DU without requiring the UE to monitor multiple search spaces. This eliminates additional UE complexity while enabling precise power control across carrier aggregation scenarios. Additionally, the direct communication between DUs reduces coordination latency compared to approaches requiring central unit involvement.

As indicated above, FIG. 5 is provided as an example. Other examples may differ from what is described with respect to FIG. 5.

FIG. 6 is a diagram illustrating an example 600 associated with power control coordination timing and status handling over a DU interface, in accordance with the present disclosure. As shown in FIG. 6, a user equipment (UE), primary distributed unit (P-DU), and secondary distributed unit (S-DU) may communicate with each other (e.g., using a D2 interface between the DUs, as described in connection with FIGS. 3-4).

The message exchanges begin, as shown by reference number 605, when the S-DU transmits a power control request message that the P-DU receives over the D2 interface. This message, which can be, e.g., an “Apply TPC Request” in O-RAN Alliance specifications, carries components needed for coordinated power control. For example, the message can include a DCI payload formatted according to 3GPP TS 38.212 specifications for power control, containing block identifiers that map to specific serving cells and their corresponding transmit power control commands. The message header can contain routing and identification information including a source identifier of the S-DU, a target identifier of the P-DU, and a UE identifier (e.g., C-RNTI) to ensure proper message handling. Upon transmission of this request, the S-DU can initiate a timer mechanism that will be used to detect potential delivery failures and trigger appropriate recovery procedures.

In some implementations, the power control request message supports power control scenarios through additional configuration parameters and timing options. When the S-DU's serving cells are conFig.d with multiple power control groups-for example, in deployments using twoPUSCH-PC-AdjustmentStates parameter as defined in 3GPP specifications—the message can include a power control group index to ensure proper command processing. This index enables precise power control even in complex scenarios where different serving cells may require different power adjustment characteristics. The S-DU may transmit these requests in various scenarios that demand immediate power adjustments, such as during semi-persistent scheduling for voice traffic where the S-DU needs to issue power control commands without accompanying uplink grants. In these cases, the coordination through the P-DU becomes particularly important as it enables power control adjustments without disrupting the established scheduling patterns.

As shown by reference number 610, the P-DU may transmit, and the S-DU may receive, a response message before the timer expiration. This response, transmitted on the D2 interface, serves multiple purposes in the power control coordination protocol. First, it provides immediate feedback about resource availability, indicating whether the P-DU successfully allocated downlink resources for transmitting the DCI format 2_2 message containing the power control commands. Additionally, the response enables the S-DU to synchronize its power control state with actual command delivery to the UE, ensuring that subsequent power control decisions account for successfully delivered commands. The timing of this response is particularly important as it must arrive before the S-DU's timer expires to prevent unnecessary failure declarations and recovery procedures.

As shown by reference number 615, the P-DU may transmit, and the UE may receive, a DCI format 2_2 message in the common search space. The DCI message contains power control commands sequenced according to block identifiers, combining commands for serving cells of both the P-DU and S-DU. When conFig.d for multiple power control groups, the transmission can include appropriately indexed commands that correspond to different PUSCH configurations of the serving cells.

The timer mechanism at the S-DU provides a foundation for power control coordination. If no response is received before the timer expires, the S-DU can select a failure status for the power control request message, triggering appropriate recovery procedures that may include message retransmission or adaptation of power control parameters. This timer-based approach balances the need for reliable command delivery with the time-sensitive nature of power control adjustments. In deployments where multiple SCells are conFig.d, each potentially requiring different power control characteristics, this reliability mechanism becomes important for maintaining consistent uplink performance across all serving cells.

By using techniques as described in connection with FIG. 6, the S-DU efficiently manages power control coordination through a combination of explicit messaging and timer-based supervision. This approach reduces coordination complexity compared to traditional methods requiring central unit involvement while maintaining precise control over uplink power settings across multiple serving cells. This also supports reliable power control in various deployment scenarios, from basic carrier aggregation configurations to complex multi-vendor deployments with diverse power control requirements. Further, the protocol's design ensures that all coordination occurs transparently to the UE, which continues to monitor only its conFig.d common search space for power control commands, regardless of the underlying inter-DU coordination complexity.

FIG. 7 is a diagram illustrating an example process 700 performed, for example, at a DU or an apparatus of a DU, in accordance with the present disclosure. Example process 700 is an example where the apparatus or the DU (e.g., DU 230) performs operations associated with interfacing for power control coordination.

At step 702, a network node, e.g., the DU or apparatus of the DU receives, from a second network node, a power control request message on an interface between the first network node and the second network node, wherein the power control request message comprises a downlink control information (DCI) payload for power control. The interface between the DU and the second network node may be a D2 interface, and the power control request message may be an “Apply TPC Request” message. Additionally, the DCI payload in the power control request message may correspond to a specific DCI format, such as DCI format 2_2. The power control request message received by the DU can include various identifiers, such as a source identifier of the second network node, a target identifier of the DU, and a user equipment (UE) identifier. These identifiers can help the DU properly process and respond to the power control request.

At step 704, the DU transmits, in a common search space monitored by the UE, a DCI message comprising the DCI payload. This allows the power control information to be conveyed to the UE through the DCI message. In some implementations, the DU may sequence the transmit power control commands included in the DCI payload. This can involve combining first commands for serving cells of the DU with the second commands received from the power control request message. The DU may also transmit a response message to the second network node, indicating the transmission status for the DCI message. This status information can specify the availability or unavailability of downlink resources for transmitting the DCI message. Additionally, the power control request message received by the DU may include a power control group index, which can be used to organize and process the power control information.

The process 700 enables coordination of power control signaling between the DU and the second network node, with the DU receiving a power control request and then transmitting the appropriate DCI message to the UE. The various implementation details, such as the interface type, message formats, and identification information, provide flexibility and adaptability to the power control coordination mechanism.

It should be appreciated that according to some implementations, at step 702, the network node, using, e.g., its reception component 902 and/or communication manager 906, receives a request for data from the medium access control (MAC) entity of the second DU. This request is received at the radio link control (RLC) entity of the first DU over the interface between the two DUs. And at step 704, the network node, utilizing its transmission component 904 and/or communication manager 906, transmits an RLC protocol data unit (PDU) on the interface in response to the request received at step 702.

Beyond the foregoing, the example process 700 may include additional aspects that enhance the coordination and information exchange between the first and second DUs. The various aspects of the example process 700 demonstrate efficient coordination and information exchange capabilities between the first and second DUs. This enables improved data transmission over the interface by allowing the DUs to adaptively manage and respond to the dynamic conditions of the wireless communication system.

It should be noted that, as shown in FIG. 7, the example process 700 may include additional blocks, fewer blocks, different blocks, or differently arranged blocks than those depicted. Furthermore, two or more of the blocks of process 700 may be performed in parallel in some aspects.

FIG. 8 is a diagram illustrating an example process 800 performed, for example, at a first network node or an apparatus of a first network node, in accordance with the present disclosure. Example process 800 is an example where the apparatus or the DU (e.g., DU 230) performs operations associated with interfacing for power control coordination.

At step 802, the first network node transmits, to a second network node, a power control request message on an interface between the first network node and the second network node, wherein the power control request message comprises a downlink control information (DCI) payload for power control. As mentioned, the message can be sent over an interface between the first and second network nodes. Also, the power control request message can include a downlink control information (DCI) payload containing information related to power control. In some implementations, the interface between the two network nodes may be conFig.d as a D2 interface, and the power control request message can be an “Apply TPC Request” message. Also, the DCI payload in the power control request message may correspond to a specific DCI format, such as DCI format 2_2.

At step 804, the first network node initiates a timer for tracking the power control request message transmitted at step 802. This timer can enable the first network node to distinguish between successful and failed power control request transmissions.

The power control request message transmitted by the first network node can include various identifiers, such as a source identifier of the first network node, a target identifier of the second network node, and a user equipment (UE) identifier. These identifiers can help the second network node properly process and respond to the power control request.

In one aspect, the DCI payload in the power control request message may specify a block identifier for a serving cell of the first network node, as well as a transmit power control command for that serving cell. The first network node can use this information to coordinate power control across its serving cells. Also, the power control request message transmitted by the first network node may include a power control group index, which can be utilized for organizing and processing the power control information.

If the timer initiated at step 804 expires without the first network node receiving a response from the second network node, the first network node may be conFig.d to select a failure status for the power control request message. Conversely, if the first network node receives a response message from the second network node prior to the timer expiring, it may be conFig.d to select a success status for the power control request.

The various aspects of the example process 800 demonstrate the sophisticated power control coordination capabilities that can be achieved between the first and second network nodes. This enables adaptive management of transmit power levels to optimize performance and reliability in the wireless communication system.

It should be noted that, as shown in FIG. 8, the example process 800 may include additional steps, fewer steps, different steps, or differently arranged steps than those depicted. Furthermore, two or more of the steps of process 800 may be performed in parallel in some aspects.

FIG. 9 is a diagram of an example apparatus 900 for wireless communication, in accordance with the present disclosure. The apparatus 900 may be a network node, or a network node may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 150 described in connection with FIG. 2. As shown, the apparatus 900 may communicate with another apparatus 908, such as a UE or another network node, using the reception component 902 and the transmission component 904. The communication manager 906 may be included in, or implemented via, a processing system of the network node.

In some aspects, the apparatus 900 may be conFig.d to perform one or more operations described herein in connection with FIGS. 5-6. Additionally, or alternatively, the apparatus 900 may be conFig.d to perform one or more processes described herein, such as process 700 of FIG. 7, or a combination thereof. In some aspects, the apparatus 900 and/or one or more components shown in FIG. 9 may include one or more components of the network node described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in one or more memories.

The reception component 902 can receive power control request messages from another network node and provide these messages to one or more other components of apparatus 900. For example, the reception component 902 may receive a power control request message containing a DCI payload for power control on an interface between network nodes. The reception component 902 may perform signal processing on received messages and provide the processed signals to other components of apparatus 900. In some aspects, the reception component 902 may include components such as radios, RF chains, or transceivers.

The transmission component 904 can transmit DCI messages comprising power control commands to UEs and response messages to other network nodes. For instance, the transmission component 904 may transmit a DCI message containing power control commands in a common search space monitored by a UE. When the apparatus 900 functions as a primary network node, the transmission component 904 may transmit response messages indicating transmission status of DCI messages to secondary network nodes. The communication manager 906 can coordinate operations between reception component 902 and transmission component 904, managing aspects such as power control command sequencing and resource availability determination.

Beyond these functionalities, apparatus 900 can support additional aspects of process 700. For example, the reception component 902 may process received power control request messages to extract identifiers, including source identifiers, target identifiers, and UE identifiers. The reception component 902 may also handle messages containing block identifiers for serving cells and corresponding transmit power control commands. The transmission component 904 may sequence power control commands, combining commands for local serving cells with commands received from other network nodes. Additionally, the communication manager 906 may process power control group indices and manage response message generation based on downlink resource availability.

The apparatus 900 can coordinate power control across multiple network nodes through message exchange and processing. When functioning as a primary network node, apparatus 900 can receive power control requests through the reception component 902, process these requests using the communication manager 906, and transmit appropriate DCI messages and responses through the transmission component 904. Through these operations, apparatus 900 enables power control coordination between network nodes serving different cells while maintaining standard UE behavior.

The components and configurations of apparatus 900 support the power control coordination mechanisms defined in process 700, which corresponds to the features recited in claim 1 and its dependent claims. The number, arrangement, and functionalities of components shown in FIG. 9 serve as an example. In practice, apparatus 900 may include additional components, fewer components, different components, or differently arranged components than those illustrated. Furthermore, responsibilities and operations may be distributed differently across components, with two or more components performing a single function or a single component performing multiple functions.

FIG. 10 is a diagram of an example apparatus 1000 for wireless communication, in accordance with the present disclosure. The apparatus 1000 may be a network node, or a network node may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 155 described in connection with FIG. 2. As shown, the apparatus 1000 may communicate with another apparatus, such as a UE or another network node, using the reception component 1002 and the transmission component 1004. The communication manager 1006 may be included in, or implemented via, a processing system of the network node.

In some aspects, the apparatus 1000 may be conFig.d to perform one or more operations described herein in connection with FIGS. 5-6. Additionally, or alternatively, the apparatus 1000 may be conFig.d to perform one or more processes described herein, such as process 800 of FIG. 8, or a combination thereof. The apparatus 1000 can support power control coordination in carrier aggregation scenarios where serving cells are distributed across multiple network nodes, particularly when apparatus 1000 functions as a secondary network node requiring power control adjustments for its serving cells.

The reception component 1002 may receive various types of communications from a UE or other network node, with particular emphasis on response messages related to power control coordination. These response messages can indicate transmission status of DCI messages, providing feedback about whether power control commands were successfully delivered to UEs through the common search space. The reception component 1002 processes these messages to extract status information, timing data, and resource availability indicators. This component may implement sophisticated signal processing techniques to handle messages received over the D2 interface, including timing recovery, error detection, and message validation. The reception component 1002 may include various hardware elements such as radios, RF chains, transceivers, or modems, each coupled with appropriate antenna configurations to support the D2 interface specifications.

The transmission component 1004 manages the generation and transmission of power control request messages containing DCI payloads. These messages follow specific formatting requirements defined in O-RAN specifications, incorporating multiple elements such as source and target identifiers, UE identifiers, and block identifiers for serving cells. When apparatus 1000 functions as a secondary network node, the transmission component 1004 formats power control commands according to DCI format 2_2 specifications, including appropriate block identifiers that map to specific serving cells under its control. The component can handle multiple power control groups, incorporating appropriate indices in the request messages to ensure proper command processing at the receiving node. The transmission component 1004 may share physical hardware with the reception component 1002, utilizing common RF chains and antenna systems while maintaining logical separation of transmission and reception functions.

The communication manager 1006 implements sophisticated control logic to coordinate power control message handling. This includes management of timer mechanisms that track message delivery status, sequencing of power control commands across multiple serving cells, and coordination of message retransmissions when necessary. The communication manager 1006 can adapt timer values based on network conditions and message priority, implement different strategies for handling timer expiration, and coordinate status selection based on various response scenarios. For messages requiring power control group indexing, the manager ensures proper formatting and inclusion of twoPUSCH-PC-AdjustmentStates parameters when conFig.d.

The transmission component 1004 supports multiple message types and formats for power control coordination. When generating Apply TPC Request messages, it incorporates DCI format 2_2 payloads structured according to, e.g., 3GPP TS 38.212 specifications. These payloads can include commands for multiple serving cells, each with appropriate block identifiers and power adjustment values. The component can handle various scenarios requiring power control adjustments, including semi-persistent scheduling situations where regular power adjustments may be needed without accompanying uplink grants.

For response message handling, the reception component 1002 implements timing-aware processing to ensure proper coordination with the timer mechanisms managed by communication manager 1006. Upon receiving responses before timer expiration, the component extracts status information and forwards it to the communication manager 1006 for appropriate status selection. The response processing includes validation of resource availability indicators and extraction of any supplementary information that may be included in the response messages.

Together, these components enable sophisticated power control coordination mechanisms. The apparatus 1000 can handle multiple simultaneous power control request messages, each with its own timer and status tracking. The apparatus 1000 supports various deployment scenarios, from basic carrier aggregation configurations to complex multi-vendor deployments with multiple power control groups. Through timer-based supervision and explicit response messaging, the apparatus maintains reliable power control command delivery while supporting flexible deployment options.

The number and arrangement of components shown in FIG. 10 serve as an example. In practice, apparatus 1000 may include additional components, fewer components, different components, or differently arranged components. Furthermore, responsibilities and operations may be distributed differently across components, with two or more components performing a single function or a single component performing multiple functions. The specific implementation may vary based on deployment requirements, hardware capabilities, and network configuration while maintaining the core power control coordination functionality.

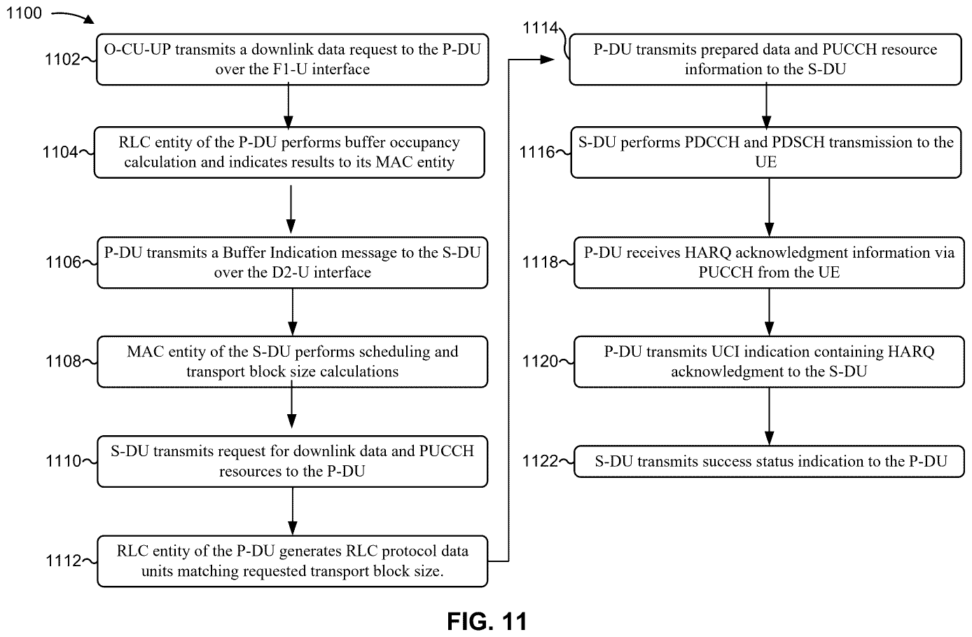

FIG. 11 is a diagram illustrating an example process 1100 associated with downlink carrier aggregation between distributed units, in accordance with the present disclosure. Process 1100 demonstrates protocol-specific message exchanges between an Open Radio Access Network (O-RAN) Central Unit User Plane (O-CU-UP), a primary distributed unit (P-DU), and a secondary distributed unit (S-DU) to coordinate data transmission to user equipment in a carrier aggregation scenario. The O-CU-UP handles user plane protocol processing in the disaggregated radio access network architecture, managing data flows between the core network and distributed units.

At block 1102, the O-CU-UP transmits a downlink data request to the P-DU over the F1-U interface. The O-CU-UP can include user plane data availability indicators and quality of service parameters in the request to enable proper handling through carrier aggregation resources.

At block 1104, the RLC entity of the P-DU performs buffer occupancy calculation and indicates the results to its MAC entity. The RLC entity can be configured to quantify available data volume and generate appropriate inter-layer signaling to enable MAC scheduling decisions.

At block 1106, the P-DU transmits a Buffer Indication message to the S-DU over the D2-U interface. The P-DU can be configured to include specific buffer occupancy metrics, such as queued data volume and associated QoS parameters, to facilitate S-DU scheduling decisions.

At block 1108, the MAC entity of the S-DU performs scheduling and transport block size calculations. The MAC entity can execute UE-specific scheduling algorithms that account for channel quality indicators, pending HARQ retransmissions, and available physical resources to determine optimal transport block sizes.

At block 1110, the S-DU transmits a request for downlink data and PUCCH resources to the P-DU over the D2 interface. The S-DU can specify the computed transport block size parameters and timing requirements for PUCCH allocation.

At block 1112, the RLC entity of the P-DU generates RLC protocol data units matching the requested transport block size. The RLC entity can be configured to perform appropriate segmentation while maintaining protocol requirements for headers and sequence numbering.

At block 1114, the P-DU transmits the prepared data and PUCCH resource information to the S-DU. The P-DU can be configured to include, e. g., K1 timing parameters, downlink assignment index, HARQ process identifier, and PUCCH resource indicators formatted according to DCI format 1_1 specifications.

At block 1116, the S-DU performs PDCCH and PDSCH transmission to the UE. The S-DU can generate control signaling and map data to physical resources according to the selected modulation and coding scheme.

At block 1118, the P-DU receives HARQ acknowledgment information via PUCCH from the UE. The P-DU can decode ACK/NACK indicators and extract associated channel state information from the received feedback.

At block 1120, the P-DU transmits UCI indication containing the HARQ acknowledgment to the S-DU. The P-DU can be configured to format and forward this control information to maintain synchronized HARQ operation across distributed units.

At block 1122, upon successful transmission confirmation, the S-DU transmits a success status indication to the P-DU. The S-DU can include relevant transmission parameters and HARQ process status to maintain protocol synchronization between distributed units.

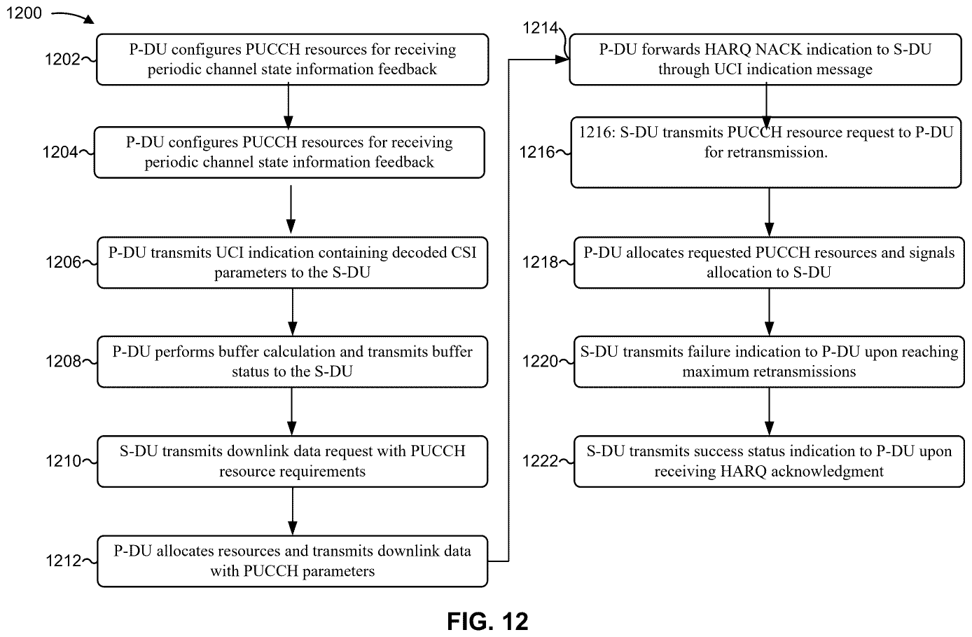

FIG. 12 is a diagram illustrating an example process 1200 associated with downlink carrier aggregation handling between distributed units with comprehensive error recovery mechanisms, in accordance with the present disclosure. Process 1200 demonstrates protocol-specific message exchanges between an Open Radio Access Network (O-RAN) Central Unit User Plane (O-CU-UP), a primary distributed unit (P-DU), and a secondary distributed unit (S-DU), focusing particularly on periodic channel state information handling and retransmission procedures.

At block 1202, the P-DU configures PUCCH resources for receiving periodic channel state information feedback for secondary cells. The P-DU can establish appropriate uplink control channel allocations that enable consistent monitoring of channel conditions across all aggregated carriers.

At block 1204, the P-DU receives PUCCH transmission containing channel state information for the secondary cell. The P-DU can be configured to extract channel quality indicators, precoding matrix indicators, and rank indicators from the received feedback.

At block 1206, the P-DU transmits UCI indication containing the decoded CSI parameters to the S-DU over the D2 interface. The P-DU can format this control information to enable the S-DU to adapt its transmission parameters based on current channel conditions.

At block 1208, the P-DU performs buffer calculation and transmits buffer status information to the S-DU via a DL Buffer Indication message. The P-DU can be configured to include current buffer occupancy metrics to facilitate scheduling decisions.

At block 1210, the S-DU transmits a downlink data request with PUCCH resource requirements to the P-DU. The S-DU can specify timing requirements and desired resources for handling potential retransmissions.

At block 1212, the P-DU allocates requested resources and transmits downlink data with associated PUCCH parameters to the S-DU. The P-DU can be configured to include K1 timing parameters, downlink assignment index, HARQ process identifier, and PUCCH resource indicators.

At block 1214, upon receiving a HARQ NACK indication via PUCCH, the P-DU forwards this feedback to the S-DU through a UCI indication message. The P-DU can be configured to trigger appropriate retransmission procedures based on the negative acknowledgment.

At block 1216, the S-DU transmits a PUCCH resource request to the P-DU for retransmission purposes. The S-DU can be configured to specify updated timing and resource requirements based on the retransmission scenario.

At block 1218, the P-DU allocates the requested PUCCH resources and signals this allocation to the S-DU. The P-DU can be configured to ensure appropriate uplink control channel availability for subsequent retransmission feedback.

At block 1220, if a maximum number of retransmissions is reached without successful acknowledgment, the S-DU transmits a failure indication to the P-DU. The S-DU can include specific failure cause information to enable appropriate error recovery procedures.

At block 1222, upon eventually receiving a successful HARQ acknowledgment, the S-DU transmits a success status indication to the P-DU. The S-DU can include relevant transmission parameters to maintain protocol synchronization between distributed units.

The following provides an overview of some Aspects of the present disclosure:

Aspect 1: An apparatus for communication at a first network node, comprising: one or more memories; and one or more processors coupled to the one or more memories, the processors configured to cause the first network node to: receive, from a second network node, a power control request message on an interface between the first network node and the second network node, wherein the power control request message comprises a downlink control information (DCI) payload for power control; and transmit, in a common search space monitored by a user equipment (UE), a DCI message comprising the DCI payload.

Aspect 2: The apparatus of Aspect 1, wherein: the interface comprises a D2 interface; the power control request message comprises an Apply TPC Request message; and the DCI message comprises at least a DCI format 2_2 message.

Aspect 3: The apparatus of Aspect 1, wherein the power control request message comprises at least one of: a source identifier of the second network node; a target identifier of the first network node; and a UE identifier.

Aspect 4: The apparatus of Aspect 1, wherein the DCI payload comprises: a block identifier for a serving cell of the second network node; and a transmit power control command for the serving cell.

Aspect 5: The apparatus of Aspect 4, wherein the one or more processors are configured to cause the first network node to: sequence transmit power control commands comprising: first commands for serving cells of the first network node; and second commands from the power control request message.

Aspect 6: The apparatus of Aspect 1, wherein the one or more processors are configured to cause the first network node to: transmit, to the second network node, a response message indicating a transmission status for the DCI message.

Aspect 11: The apparatus of Aspect 6, wherein the transmission status indicates availability or unavailability of downlink resources for the DCI message.

Aspect 8: The apparatus of Aspect 1, wherein the power control request message comprises a power control group index.

Aspect 9: An apparatus for communication at a first network node, comprising: one or more memories; and one or more processors, coupled to the one or more memories, configured to cause the first network node to: transmit, to a second network node, a power control request message on an interface between the first network node and the second network node, wherein the power control request message comprises a downlink control information (DCI) payload for power control; and initiate a timer for the power control request message.

Aspect 10: The apparatus of Aspect 9, wherein: the interface comprises a D2 interface; the power control request message comprises an Apply TPC Request message; and the DCI payload corresponds to a DCI format 2_2 message.

Aspect 11: The apparatus of Aspect 9, wherein the one or more processors are configured to cause the first network node to: select a failure status for the power control request message upon expiration of the timer.

Aspect 12: The apparatus of Aspect 9, wherein the power control request message comprises: a source identifier of the first network node; a target identifier of the second network node; and a UE identifier.

Aspect 13: The apparatus of Aspect 9, wherein the DCI payload comprises: a block identifier for a serving cell of the first network node; and a transmit power control command for the serving cell.

Aspect 14: The apparatus of Aspect 9, wherein the power control request message comprises a power control group index.

Aspect 15: The apparatus of Aspect 9, wherein the one or more processors are configured to cause the first network node to: receive a response message from the second network node prior to expiration of the timer; and select a success status for the power control request message.

Aspect 16: A method for wireless communication, comprising: receiving, at a first network node and from a second network node, a power control request message on an interface between the first network node and the second network node, wherein the power control request message comprises a downlink control information (DCI) payload for power control; and transmitting, in a common search space monitored by a user equipment (UE), a DCI message comprising the DCI payload.

Aspect 111: The method of Aspect 16, wherein: the interface comprises a D2 interface; the power control request message comprises an Apply TPC Request message; and the DCI message comprises a DCI format 2_2 message.

Aspect 18: The method of Aspect 16, wherein the power control request message comprises at least one of: a source identifier of the second network node; a target identifier of the first network node; and a UE identifier.

Aspect 19: The method of Aspect 16, wherein the DCI payload comprises: a block identifier for a serving cell of the second network node; and a transmit power control command for the serving cell.

Aspect 20: The method of Aspect 19, further comprising: sequencing transmit power control commands comprising: first commands for serving cells of the first network node; and second commands from the power control request message.

Aspect 21: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-20.

Aspect 22: An apparatus for wireless communication at a device, the apparatus comprising one or more memories and one or more processors coupled to the one or more memories, the one or more processors configured to cause the device to perform the method of one or more of Aspects 1-20.

Aspect 23: An apparatus for wireless communication, the apparatus comprising at least one means for performing the method of one or more of Aspects 1-20.

Aspect 24: A non-transitory computer-readable medium storing code for wireless communication, the code comprising instructions executable by one or more processors to perform the method of one or more of Aspects 1-20.

Aspect 25: A non-transitory computer-readable medium storing a set of instructions for wireless communication, the set of instructions comprising one or more instructions that, when executed by one or more processors of a device, cause the device to perform the method of one or more of Aspects 1-20.

Aspect 26: A device for wireless communication, the device comprising a processing system that includes one or more processors and one or more memories coupled with the one or more processors, the processing system configured to cause the device to perform the method of one or more of Aspects 1-20.

Aspect 211: An apparatus for wireless communication at a device, the apparatus comprising one or more memories and one or more processors coupled to the one or more memories, the one or more processors individually or collectively configured to cause the device to perform the method of one or more of Aspects 1-20.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

1. An apparatus for communication at a first network node, comprising:
one or more memories; and
one or more processors coupled to the one or more memories, the processors configured to cause the first network node to:
receive, from a second network node, a power control request message on an interface between the first network node and the second network node, wherein the power control request message comprises a downlink control information (DCI) payload for power control; and
transmit, in a common search space monitored by a user equipment (UE), a DCI message comprising the DCI payload.

2. The apparatus of claim 1, wherein:
the interface comprises a D2 interface;
the power control request message comprises an Apply TPC Request message; and
the DCI message comprises at least a DCI format 2_2 message.

3. The apparatus of claim 1, wherein the power control request message comprises at least one of:
a source identifier of the second network node;
a target identifier of the first network node; and
a UE identifier.

4. The apparatus of claim 1, wherein the DCI payload comprises:
a block identifier for a serving cell of the second network node; and
a transmit power control command for the serving cell.

5. The apparatus of claim 4, wherein the one or more processors are configured to cause the first network node to:
sequence transmit power control commands comprising:
first commands for serving cells of the first network node; and
second commands from the power control request message.

6. The apparatus of claim 1, wherein the one or more processors are configured to cause the first network node to:
transmit, to the second network node, a response message indicating a transmission status for the DCI message.

7. The apparatus of claim 6, wherein the transmission status indicates availability or unavailability of downlink resources for the DCI message.

8. The apparatus of claim 1, wherein the power control request message comprises a power control group index.

9. An apparatus for communication at a first network node, comprising:
one or more memories; and
one or more processors, coupled to the one or more memories, configured to cause the first network node to:
transmit, to a second network node, a power control request message on an interface between the first network node and the second network node, wherein the power control request message comprises a downlink control information (DCI) payload for power control; and
initiate a timer for the power control request message.

10. The apparatus of claim 9, wherein:
the interface comprises a D2 interface;
the power control request message comprises an Apply TPC Request message; and
the DCI payload corresponds to a DCI format 2_2 message.

11. The apparatus of claim 9, wherein the one or more processors are configured to cause the first network node to:
select a failure status for the power control request message upon expiration of the timer.

12. The apparatus of claim 9, wherein the power control request message comprises:
a source identifier of the first network node;
a target identifier of the second network node; and
a UE identifier.

13. The apparatus of claim 9, wherein the DCI payload comprises:
a block identifier for a serving cell of the first network node; and
a transmit power control command for the serving cell.

14. The apparatus of claim 9, wherein the power control request message comprises a power control group index.

15. The apparatus of claim 9, wherein the one or more processors are configured to cause the first network node to:
receive a response message from the second network node prior to expiration of the timer; and
select a success status for the power control request message.

16. A method for wireless communication, comprising:
receiving, at a first network node and from a second network node, a power control request message on an interface between the first network node and the second network node, wherein the power control request message comprises a downlink control information (DCI) payload for power control; and
transmitting, in a common search space monitored by a user equipment (UE), a DCI message comprising the DCI payload.

17. The method of claim 16, wherein:
the interface comprises a D2 interface;
the power control request message comprises an Apply TPC Request message; and
the DCI message comprises a DCI format 2_2 message.

18. The method of claim 16, wherein the power control request message comprises at least one of:
a source identifier of the second network node;
a target identifier of the first network node; and
a UE identifier.

19. The method of claim 16, wherein the DCI payload comprises:
a block identifier for a serving cell of the second network node; and
a transmit power control command for the serving cell.

20. The method of claim 19, further comprising:
sequencing transmit power control commands comprising:
first commands for serving cells of the first network node; and
second commands from the power control request message.
